(19) United States
(12) Patent Application Publication
(10) Pub. No.: US 2025/0111518 A1
(43) Pub. Date: Apr. 3, 2025

(54) OBJECT MEASUREMENT DEVICE AND OBJECT MEASUREMENT METHOD

(71) Applicant: TOPCON CORPORATION, Itabashi-ku, Tokyo (JP)

(72) Inventors: Toru ITO, Wako (JP); Yasufumi FUKUMA, Wako (JP); Zaixing MAO, Wako (JP); Hisashi TSUKADA, Wako (JP)

(21) Appl. No.: 18/726,358

(22) PCT Filed: Dec. 23, 2022
(86) PCT No.: PCT/JP2022/047602

§ 371 Date: Jul. 2, 2024

(30) Foreign Application Priority Data
Jan. 5, 2022 (JP) 2022-000640

(51) Int. Cl. G06T 7/12; G06T 7/50; G06T 7/60; G06V 10/44; G06V 10/70; G06V 10/74; G06V 20/70

(52) U.S. Cl. CPC G06T 7/12; G06T 7/50; G06T 7/60; G06V 10/44; G06V 10/70; G06V 10/761; G06V 20/70; G06T 2207/20081

(57) ABSTRACT

Provided is an object measurement device for measuring the shape of an object by recognizing the object using a machine learning model, automating determination of an edge detection direction and determination of a region for performing edge processing, and performing highly accurate edge extraction in units of sub-pixels, for example. An object measurement device according to the present invention comprises: an object recognition unit that recognizes an object in an image by inputting an acquired image as input data into a trained model, and outputs a region of the object as a recognition result; an edge detection direction determination unit that determines an edge detection direction for the region of the object recognized by the object recognition unit; an edge processing region determination unit that determines an edge processing region for the region of the object recognized by the object recognition unit; and an edge detection unit that performs edge detection in the edge detection direction determined by the edge detection direction determination unit, for the edge processing region determined by the edge processing region determination unit.

### TECHNICAL FIELD

The present invention relates to an object measurement device and an object measurement method, and more particularly, to an object measurement device and an object measurement method for measuring the shape of an object present in a space with high accuracy.

### BACKGROUND ART

To check the construction status of a structure such as a building under construction, it is necessary to recognize shapes of objects that should be recognized as construction materials in a space with high accuracy. Attempts have been made to acquire data inside a space with cameras or sensors and measure the shapes of objects. However, because there are many objects such as pipes, pillars, ducts, window frames, and panels in the space of a building or the like under construction, it is difficult to automate the determination of which of many lines and curves extracted from acquired images should be considered as objects that should be recognized as construction materials. Thus, the regions of objects are often specified manually, which disadvantageously consumes time and effort.

On the other hand, in recognizing objects in a space using a system that automatically recognizes objects in acquired images, rather than manually, it has been difficult to achieve sufficient accuracy for the purpose of use that requires higher accuracy. For example, for the purpose of grasping the construction status of a structure under construction, it is necessary to know whether construction materials are placed as planned and therefore, correctly measure the positions, shapes, and dimensions of the construction materials. There is a need for a system sufficiently serving such a purpose.

For example, Patent Literature 1 discloses a construction production system including: “a CPU that functions as: existing portion investigation means for converting electronic data of an existing portion of a structure acquired from an existing drawing into three-dimensional CAD data, and for storing the three-dimensional CAD data together with various job site investigation data including point cloud data acquired by a three-dimensional laser scanner and a three-dimensional polygon model created from the point cloud data; construction member design means for disposing a member object to be newly constructed, which is selected from among member objects stored in advance in a member library, on the three-dimensional polygon model; and member construction position output means for searching for and outputting the member object corresponding to an ID unique to the member object obtained by reading an electronic tag attached to a member precut in a member factory with an ID reader together with construction position information thereof from the three-dimensional CAD model designed by the construction member design means according to the member object disposed by the construction member design means; and an automatic position pointing device for pointing a construction position of the member in the existing portion on the basis of construction position information of the member object output by the member construction position output means of the CPU”.

Further, Patent Literature 2 discloses “an image processing device including: an image acquisition unit that acquires an input image generated by imaging a real space using an imaging device; a recognition unit that recognizes a relative position and posture between the real space and the imaging device on the basis of one or more feature points imaged in the input image; an application unit that provides an augmented reality application using the recognized relative position and posture; and a display control unit that overlaps, on the input image, a guiding object that guides a user operating the imaging device in accordance with a distribution of the feature points so that recognition processing executed by the recognition unit is stabilized”.

Although the techniques for grasping a three-dimensional space or objects in a three-dimensional space are disclosed, the techniques are unsuitable for efficiently grasping construction materials of interest in a space and measuring shapes of objects with high accuracy, particularly in a site such as a building under construction or a factory that intricately involves many objects, for example, pillars, ducts, window frames, and panels in the space.

### CITATION LIST

### Patent Literature

PATENT LITERATURE 1: JP-A-2013-149119

PATENT LITERATURE 2: JP-A-2013-225245

### SUMMARY OF INVENTION

### Technical Problem

The present invention solves the above problems and provides an object measurement device for measuring the shape of an object by recognizing the object with a machine learning model, automating determination of an edge detection direction and determination of a region to be subjected to edge processing, and performing highly accurate edge extraction in units of sub-pixels, for example.

Further, the present invention provides a machine learning model generation device for generating a machine learning model used in an object measurement device for measuring the shape of an object by recognizing the object with the machine learning model, automating determination of an edge detection direction and determination of a region to be subjected to edge processing, and performing highly accurate edge extraction in units of sub-pixels, for example.

Further, the present invention provides an object measurement system including an object measurement device for measuring the shape of an object by recognizing the object with a machine learning model, automating determination of an edge detection direction and determination of a region to be subjected to edge processing, and performing highly accurate edge extraction in units of sub-pixels, for example.

Further, the present invention provides an object measurement method for measuring the shape of an object including the steps of: recognizing an object with a machine learning model; automating determination of an edge detection direction and determination of a region to be subjected to edge processing; and performing highly accurate edge extraction in units of sub-pixels, for example.

Further, the present invention provides a program that causes a computer to execute the steps of the object measurement method described above.

### Solution to Problem

To solve the above problems, the present invention provides an object measurement device including: an object recognition unit that recognizes an object region in an acquired image by inputting the acquired image as input data into a learned model, and outputs the object region as a recognition result; an edge detection direction determination unit that determines an edge detection direction for the object region recognized by the object recognition unit; an edge processing region determination unit that determines an edge processing region for the object region recognized by the object recognition unit; and an edge detection unit that performs edge detection on the edge processing region determined by the edge processing region determination unit in the edge detection direction determined by the edge detection direction determination unit.

In the object measurement device of the present invention, the learned model used by the object recognition unit in recognizing the object region is generated through machine learning that uses a correct image generated from Building Information Modeling (BIM) data as correct data and a virtual observation image generated through rendering the BIM data as observation data.

In the object measurement device of the present invention, the edge detection direction determination unit generates approximation lines that are obtained by approximating a boundary curve indicating the boundary of the object region recognized by the object recognition unit to straight lines and that include an approximate line in a first direction and an approximate line in a second direction perpendicular to the first direction, compares the approximate line in the first direction and the approximate line in the second direction, and determines the approximate line, whichever is longer, as an edge that composes an object to be measured.

In the object measurement device of the present invention, the edge processing region determination unit determines, as an edge processing region, a range in which a distance from the edge determined by the edge detection direction determination unit in a direction perpendicular to the edge is equal to or smaller than a threshold value.

The present invention also provides an object measurement method including the steps of: recognizing an object in an acquired image by inputting the acquired image as input data into a learned model, and outputting a region of the object as a recognition result; determining an edge detection direction for the region of the object output as the recognition result; determining an edge processing region for the region of the object output as the recognition result; and performing edge detection on the edge processing region.

The present invention also provides a program that causes a computer to execute the steps of the object measurement method described above.

In the present invention, “Building Information Modeling (BIM) data” refers to data of a three-dimensional model of a building reproduced on a computer.

In the present invention, a “real image” refers to an image such as a photograph obtained by photographing the real world with a camera.

### Advantageous Effects of Invention

The present invention produces the effect that the shape of an object in a space can be measured with accuracy in units of sub-pixels, and that the object measurement can be achieved with higher accuracy than accuracy improved through image resolution, object recognition with machine learning, or ingenious scanning of objects with cameras or the like. The present invention also allows measuring the shape of an object with sufficient accuracy when used to grasp the construction status of a structure under construction at a site or the like.

Other objects, features and advantages of the present invention will become apparent from the following description of embodiments of the present invention with reference to the accompanying drawings.

### BRIEF DESCRIPTION OF DRAWINGS

FIG. 1 is a schematic diagram showing the whole of an object measurement device according to the present invention.

FIG. 2 is a diagram showing an overview of a machine learning model generation device of the present invention.

FIG. 3 is a diagram showing an overview of the processing in an object recognition unit of the present invention.

FIG. 4 is a diagram showing an overview of the processing in an edge detection direction determination unit of the present invention.

FIG. 5 a diagram showing an overview of the processing in an edge processing region determination unit of the present invention.

FIG. 6 is a diagram showing an overview of the processing in an edge detection unit of the present invention.

FIG. 7 is a diagram showing a flowchart of the processing in the object measurement device of the present invention.

### DESCRIPTION OF EMBODIMENTS

### Embodiment 1

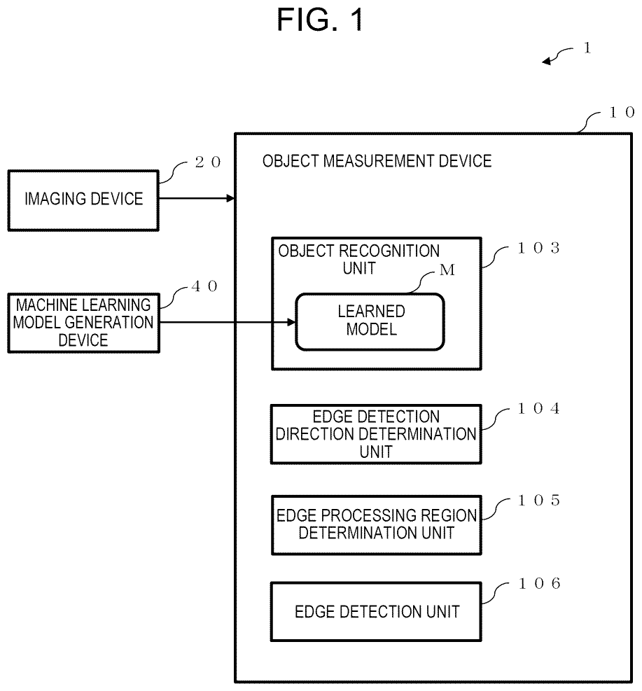

FIG. 1 is a schematic diagram showing the whole of an object measurement device 10 according to the present invention.

The object measurement device 10 according to the present invention includes: an object recognition unit 103 that recognizes an object in an acquired image by inputting the acquired image as input data into a learned model M, and outputs a region of the object (an object region) as a recognition result; an edge detection direction determination unit 104 that determines an edge detection direction for the object region recognized by the object recognition unit 103; an edge processing region determination unit 105 that determines an edge processing region for the object region recognized by the object recognition unit 103; and an edge detection unit 106 that performs edge detection on the edge processing region determined by the edge processing region determination unit 105.

The object measurement device 10 may form a part of an object measurement system 1. The object measurement system 1 is used for recognizing an object in a space with a machine learning model and measuring the position, shape, dimension and the like of the object. For example, to check work progress at a site under construction, the object measurement system 1 may be used for recognizing structures such as pipes, ducts, pillars, walls, window frames, cables, panels, etc. included in an image photographed in the construction site with a camera, and determining their positions, shapes, dimensions and the like.

The object measurement system 1 may include an imaging device 20. The imaging device 20 may be any camera such as a still image camera, a video camera, a mobile camera mounted on a mobile terminal, and a CCD camera. An input image to be recognized by the object measurement system 1 is a real image such as a site photograph obtained by photographing a site under construction, for example. The real image is an image acquired from the imaging device 20. When the object measurement system 1 does not include the imaging device 20, images captured by external imaging means and stored in advance, for example, in a database or a memory (not shown) may be used.

The object measurement system 1 includes a machine learning model generation device 40. The object measurement device 10 recognizes an object in a space with a machine-learned model generated by the machine learning model generation device 40. When a new machine-learned model is generated by the machine learning model generation device 40, the object measurement system 1 may update the machine-learned model in the object measurement device 10 to the new machine-learned model.

The functions involved in the machine learning model generation device 40 may be built on a cloud service. When the machine learning model generation device 40 and the object measurement device 10 are physically distant, they may exchange data or the like with each other over a network.

The object recognition unit 103 recognizes an object in an acquired image by inputting the acquired image as input data into a learned model, and outputs a region of the object as a recognition result. Here, the image as input data is an image acquired from the imaging device 20. However, it may be an image stored in advance, for example, in a database or a memory (not shown).

The edge detection direction determination unit 104 determines an edge detection direction of the object region recognized by the object recognition unit 103.

The edge processing region determination unit 105 determines an edge processing region for the object region recognized by the object recognition unit 103.

The edge detection unit 106 performs edge detection on the edge processing region determined by the edge processing region determination unit 105.

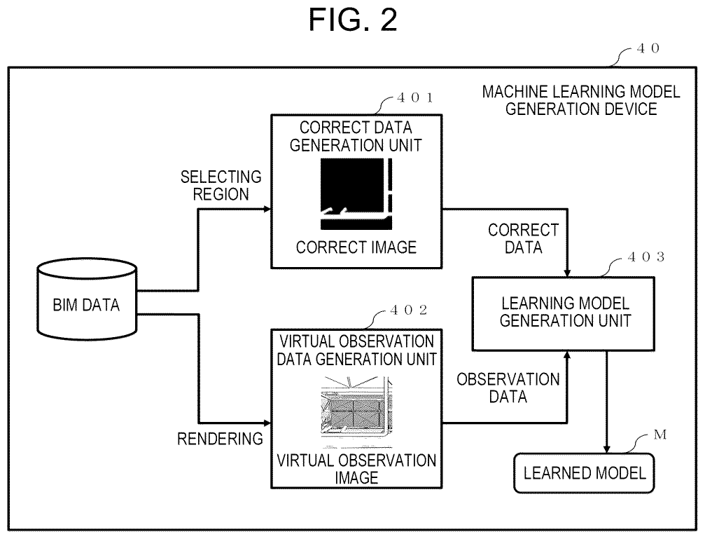

FIG. 2 is a diagram showing an overview of the machine learning model generation device 40 of the present invention.

The machine learning model generation device 40 generates a learned model M used for recognizing an object in a space. The machine learning model generation device 40 executes machine learning that uses a correct image generated from Building Information Modeling (BIM) data as correct data and a virtual observation image generated through rendering the BIM data as observation data to generate the learned model M. Although the machine learning is preferably executed through deep learning with neural networks, other machine learning techniques can also be used. The learned model M is generated by the machine learning model generation device 40 in advance of the measurement by the object measurement device 10.

The machine learning model generation device 40 includes a correct data generation unit 401 that generates correct data from BIM data, a virtual observation data generation unit 402 that renders the BIM data to generate a virtual observation image, and a learning model generation unit 403 that executes machine learning that uses the correct image generated by the correct data generation unit 401 as correct data and the virtual observation image as observation data to generate a learned model M.

The correct data generation unit 401 generates a correct image from BIM data. The correct image is used as correct data in generating a machine learning model in the learning model generation unit 403. The correct image may be a mask image having a mask region indicating a structure. The correct image may be a binarized image generated from the BIM data as shown in FIG. 2, for example. The correct image is not limited to the example of FIG. 2, and may be an image in another form depending on the structure to be recognized.

Here, “BIM data” refers to data of a three-dimensional model of a building reproduced on a computer. The BIM data generally includes information on the three-dimensional structure of a building. In addition, as the BIM data treats building materials as objects for each part, it can include information other than the drawing, such as the width, depth, height, material, assembly process, and time required for assembly, for each part. Through rendering the BIM data, an image of the three-dimensional space can be obtained. The rendered image may be a three-dimensional expression so that the appearance of an actual site is reproduced, and part thereof can also be extracted as a two-dimensional image. The rendered image may be subjected to image processing such as binarization, thinning, and skeletonization. Although the BIM data is stored in a database for storing the BIM data in the example of FIG. 2, the database storing the BIM data may be located outside the machine learning model generation device 40.

The virtual observation data generation unit 402 renders the BIM data to generate a virtual observation image. The virtual observation image generated through rendering the BIM data is, for example, an image that looks like a reproduction of a real image as shown in FIG. 2.

The learning model generation unit 403 executes machine learning that uses the correct image generated by a correct image generation unit as correct data and the virtual observation image as observation data to generate a learned model M. In this way, correct images and virtual observation images generated from the BIM data are used instead of real images such as site photographs, which can eliminate the problem of time and effort and difficulty in collecting an enormous number of real images such as site photographs for machine learning.

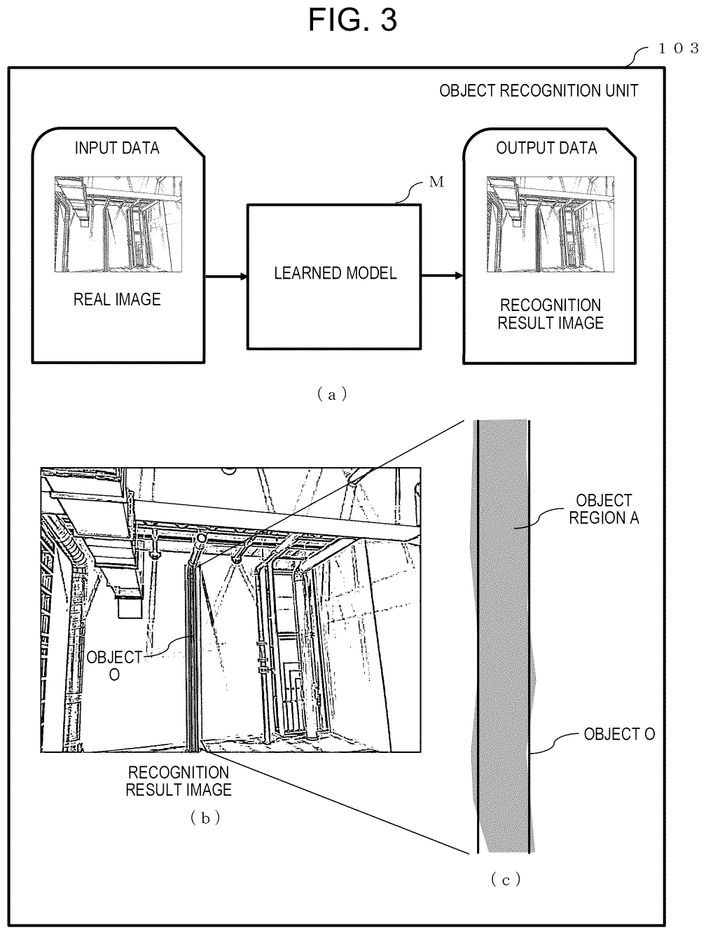

FIG. 3 is a diagram showing an overview of the processing in the object recognition unit 103 of the present invention.

The object recognition unit 103 recognizes an object region in an acquired image by inputting the acquired image as input data into a learned model M, and outputs the object region as a recognition result. The learned model M used by the object recognition unit 103 to recognize the object region A is preferably generated through machine learning that uses a correct image generated from Building Information Modeling (BIM) data as correct data and a virtual observation image generated through rendering the BIM data as observation data. The learned model M is generated in advance by the machine learning model generation device 40. The learned model M is not limited to the example, but may be generated with other techniques in which an object region can be recognized from an image.

FIG. 3(a) shows the relationship between input data to the learned model M and output data from the learning model M. The input data to the learning model M is an image acquired from the imaging device 20 or the like, and the output data from the learning model M is a recognition result image including an object region as a recognition result.

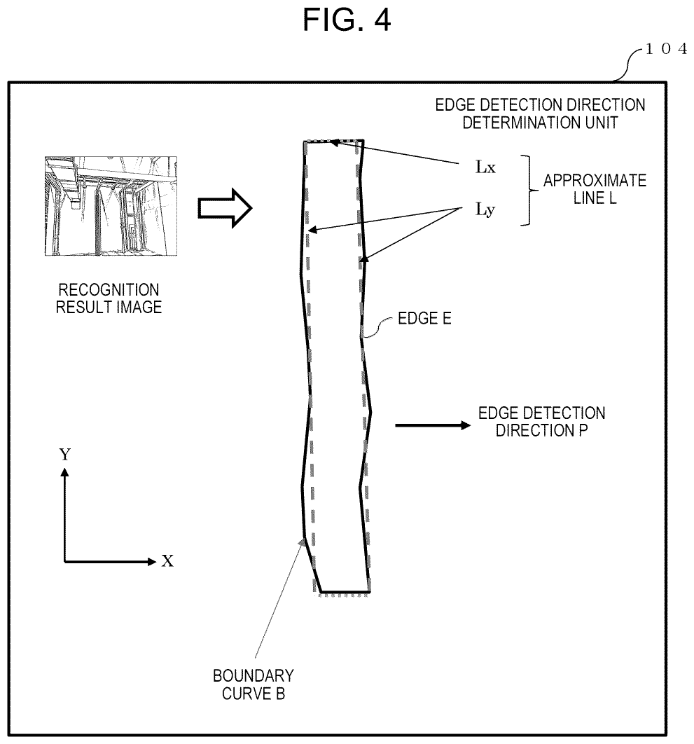

FIG. 3(b) is an enlarged view of the recognition result image. The example in FIG. 4(b) shows a result in which an object O is recognized as the object to be measured (in this example, a pipe). The region of the object to be measured is recognized as an object region A.

FIG. 3(c) is an enlarged view showing the object region A recognized by the object recognition unit 103 in the recognition result image. In FIG. 4(c), the object O schematically expresses the edge of an actual object, and the object region A expresses the recognized object region. As shown in FIG. 4(c), a slight mismatch is produced between the edge of the object region A recognized by the object recognition unit 103 and the edge of the actual object O. Processing to correct the mismatch and provide higher accuracy edge detection is performed in the edge detection direction determination unit 104, the edge processing region determination unit 105, and the edge detection unit 106, as described later.

FIG. 4 is a diagram showing an overview of the processing in the edge detection direction determination unit 104 of the present invention.

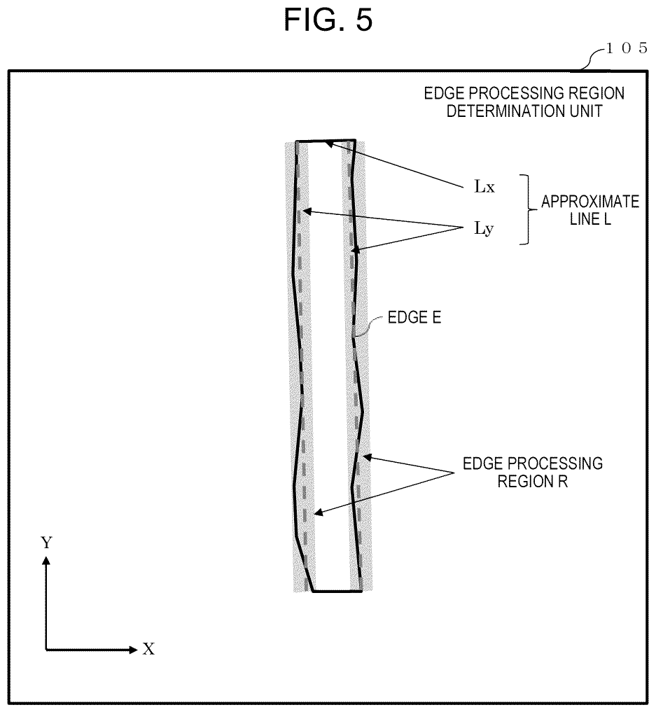

The edge detection direction determination unit 104 determines an edge detection direction for the object region A of the object recognized by the object recognition unit 103. A boundary curve B in FIG. 5 indicates the boundary of the object region A recognized by the object recognition unit 103. Approximate lines L in FIG. 4 are obtained by approximating the boundary curve B to straight lines. The approximate lines L include an approximate line Lx in a first direction (X direction in FIG. 4) and an approximate line Ly in a second direction (Y direction in FIG. 4) perpendicular to the first direction (X direction in FIG. 4). The edge detection direction determination unit 104 compares the approximate line Lx in the first direction (X direction in FIG. 4) and the approximate line Ly in the second direction (Y direction in FIG. 4) perpendicular to the first direction, and determines the approximate line, whichever is longer, as the edge E that composes the object to be measured. Since a shorter approximate line is more susceptible to the effects of shadows, noise, occlusion or the like, the longer one of the approximate lines Lx and Ly is determined as the edge E that composes the object to be measured. In the example in FIG. 4, since the approximate line Ly in Y direction is longer than the approximate line Lx in X direction, the approximate line Ly is determined as the edge E of the object O. Once the edge E is determined, the edge detection direction determination unit 104 determines the direction P perpendicular to the edge E as the edge detection direction, which is used as the edge detection direction in the later edge detection by the edge detection unit 106.

FIG. 5 is a diagram showing an overview of the processing in the edge processing region determination unit 105 of the present invention.

The edge processing region determination unit 105 determines an edge processing region R for the edge E determined by the edge detection direction determination unit 104 as a region to be subjected to edge processing. The edge processing region determination unit 105 determines, as an edge processing region R, a range in which a distance from the edge E determined by the edge detection direction determination unit 104 in the direction perpendicular to the edge E is equal to or smaller than a threshold value S. The threshold value S is determined according to the amount of amplitude of the mismatch between the edge of the object region A recognized by the object recognition unit 103 and the actual edge of the object O. The value of the threshold S may be adjustable according to the extent of incorrect recognition by the object recognition unit 103 obtained in the actual recognition processing or previous verification.

In other words, the edge processing region R is a region between two lines parallel to the edge E that are spaced a predetermined distance D from the edge E in the positive and negative X directions, respectively. The value of the distance D is determined according to the amount of amplitude of the mismatch between the edge of the object region A recognized by the object recognition unit 103 and the actual edge of the object O. The distance D may be adjustable according to the extent of incorrect recognition by the object recognition unit 103 obtained in the actual recognition processing or advance verification.

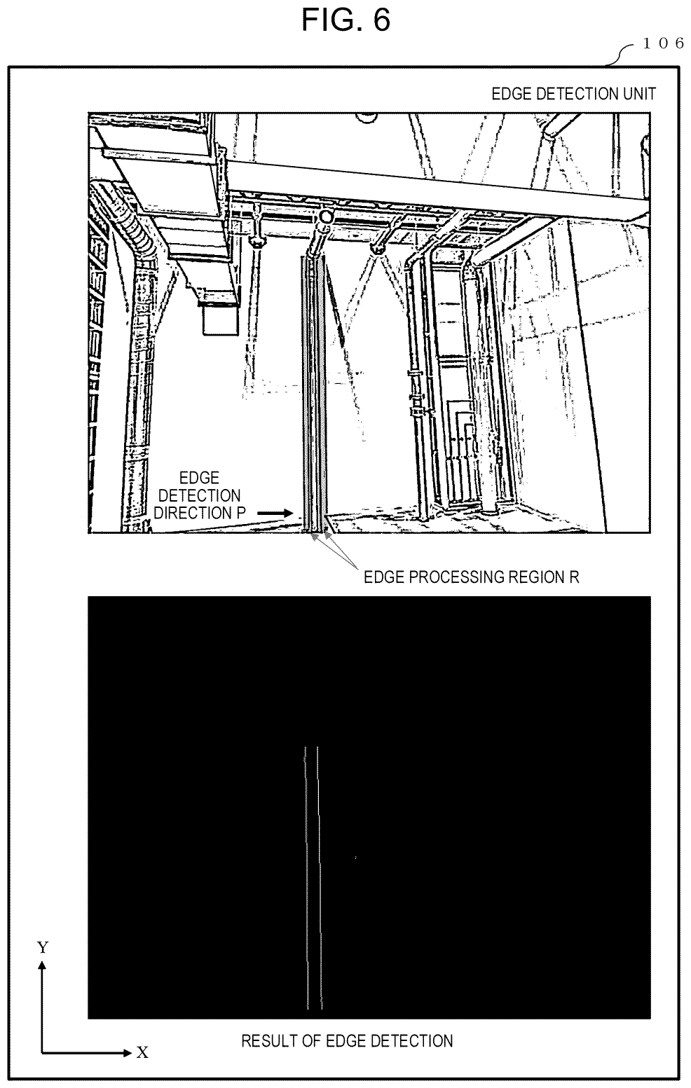

FIG. 6 is a diagram showing an overview of the processing in the edge detection unit 106 of the present invention.

The edge detection unit 106 performs edge detection on the edge processing region R determined by the edge processing region determination unit 105 in the edge detection direction P determined by the edge detection direction determination unit 104. The edge detection unit 106 can perform the edge detection using any existing edge detection technique such as a Sobel filter and a Laplacian filter. For example, when Canny is used as the edge detection technique, noise may be removed through smoothing with a Gaussian filter, edges may be detected through differential processing with a Sobel filter, a maximum value may be detected to remove parts other than the edge, and two-stage threshold processing may be performed.

In the edge detection, the edge detection unit 106 may perform sub-pixel processing on an image to be processed. Although the sub-pixel processing is preferably performed only on the edge processing region R determined by the edge processing region determination unit 105 or on the peripheral region of the edge processing region R containing the edge processing region R, the sub-pixel processing may be performed entirely on the image to be processed. Here, “sub-pixel processing” refers to the processing in which the density of sub-pixels, which are less than one pixel, is determined through interpolation on the basis of the surrounding pixel densities or the like to perform image processing with an accuracy of less than one pixel. For the density interpolation in the sub-pixel processing, an existing technique such as linear interpolation may be used. For example, the density interpolation may be performed in units of sub-pixels, with the focus on three neighboring pixels.

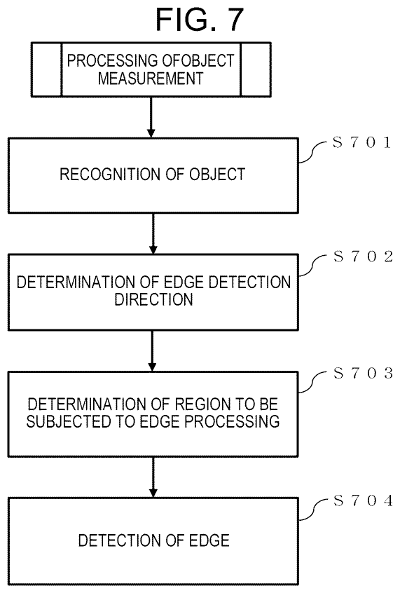

FIG. 7 is a diagram showing a flowchart of the processing in the object measurement device of the present invention.

First, in step S701, an object is recognized. Next, in step S702, an edge detection direction is determined. Next, in step S703, a region to be subjected to edge processing is determined. Next, in step S704, an edge is detected.

In step S701, an object in an acquired image is recognized by inputting the acquired image as input data into a learned model, and a region of the object is output as a recognition result. Step S701 is executed by the object recognition unit 103 described above.

In step S702, an edge detection direction is determined for the object region output as the recognition result. Step S702 is executed by the edge detection direction determination unit 104 described above.

In step S703, an edge processing region is determined for the object region output as the recognition result. Step S703 is executed by the edge processing region determination unit 105 described above.

In step S704, edge detection is performed on the determined edge processing region. Step S704 is executed by the edge detection unit 106 described above.

In the above embodiment, an example has been described in which the machine learning model generation device 40 executes machine learning that uses a correct image generated from BIM data as correct data and a virtual observation image generated through rendering the BIM data as observation data to generate a learned model M, with reference to FIG. 2. However, the present invention is not limited to the example and the object measurement device 10 of the present invention may use a learned model generated with another technique. For example, the correct image may be generated from many collected real images instead of the correct image generated from the BIM data, and be used as correct data for machine learning. Further, many collected real images, instead of the virtual observation image generated from the BIM data, may be used as observation data for machine learning.

In another modification related the configuration of the machine learning model generation device 40, in addition to the correct image generated from the BIM data, an enhanced image obtained through image processing on a correct image may be employed as the correct data used for generating the learned model M in the learning model generation unit 403. For example, an enhanced image may be used in which a center line or a feature line is extracted through image processing such as thinning on a correct image.

In still another modification related the configuration of the machine learning model generation device 40, an enhanced virtual observation image obtained through image processing on a virtual observation image generated from BIM data may be employed as virtual observation data used for generating the learned model M in the learning model generation unit 403. For example, an enhanced virtual observation image in which a texture is added to an object of interest in a virtual observation image may be used.

The above-mentioned two modifications can be implemented in any combination on the object measurement device 10 of the present invention described in the above embodiment. Further, the object measurement system 1 having an aspect involving any combination of these modifications may be implemented.

According to the object measurement system, the object measurement device, and the object measurement method according to the present invention described above, an object is recognized with a machine learning model, determination of an edge detection direction and determination of a region to be subjected to edge processing are automated, sub-pixel processing is executed as required, thereby the shape of the object in a space can be measured with high accuracy, for example, in units of sub-pixels. Therefore, the object measurement can be achieved with higher accuracy than accuracy improved through image resolution, object recognition with machine learning, or ingenious scanning of objects with cameras or the like. Furthermore, the present invention also allows measuring the shape of an object with sufficient accuracy when used to grasp the construction status of a structure under construction at a site or the like. The present invention can also be applied to situations, other than construction sites, where highly accurate measurement of the shape of an object is required, such as inspection and dimensional measurement of products.

Although the above description has been made regarding the embodiments, it will be apparent to those skilled in the art that the present invention is not limited thereto, and that various changes and modifications can be made within the scope of the principles of the present invention and the appended claims.

### REFERENCE SIGNS LIST

1 object measurement system
10 object measurement device
20 imaging device
40 machine learning model generation device
103 object recognition unit
104 edge detection direction determination unit
105 edge processing region determination unit
106 edge detection unit

1. An object measurement device comprising:
an object recognition unit that recognizes an object region in an acquired image by inputting the acquired image as input data into a learned model, and outputs the object region as a recognition result;
an edge detection direction determination unit that determines an edge detection direction for the object region recognized by the object recognition unit;
an edge processing region determination unit that determines an edge processing region for the object region recognized by the object recognition unit; and
an edge detection unit that performs edge detection on the edge processing region determined by the edge processing region determination unit in the edge detection direction determined by the edge detection direction determination unit.

2. The object measurement device according to claim 1, wherein the learned model used by the object recognition unit in recognizing the object region is generated through machine learning that uses a correct image generated from Building Information Modeling (BIM) data as correct data and a virtual observation image generated through rendering the BIM data as observation data.

3. The object measurement device according to claim 1, wherein the edge detection direction determination unit generates approximation lines that are obtained by approximating a boundary curve indicating a boundary of the object region recognized by the object recognition unit to straight lines and that include an approximate line in a first direction and an approximate line in a second direction perpendicular to the first direction, compares the approximate line in the first direction and the approximate line in the second direction, and determines the approximate line, whichever is longer, as an edge that composes an object to be measured.

4. The object measurement device according to claim 1, wherein the edge processing region determination unit determines, as an edge processing region, a range in which a distance from the edge determined by the edge detection direction determination unit in a direction perpendicular to the edge is equal to or smaller than a threshold value.

5. An object measurement method comprising the steps of:
recognizing an object in an acquired image by inputting the acquired image as input data into a learned model, and outputting a region of the object as a recognition result;
determining an edge detection direction for the region of the object output as the recognition result;
determining an edge processing region for the region of the object output as the recognition result; and
performing edge detection on the edge processing region.

6. A program that causes a computer to execute each step of the method according to claim 5.
